(19) United States
(12) Patent Application Publication
(10) Pub. No.: US 2026/0285137 A1
(43) Pub. Date: Sep. 24, 2026

(54) STRUCTURE OF VEHICLE BODY

(71) Applicants: Hyundai Motor Company, Seoul (KR); Kia Corporation, Seoul (KR)

(72) Inventors: Seung Min Jeong, Hwaseong-si (KR); Huen Sick Min, Hwaseong-si (KR); Joo Nam Kim, Hwaseong-si (KR)

(21) Appl. No.: 19/279,072

(22) Filed: Jul. 24, 2025

(30) Foreign Application Priority Data
Mar. 19, 2025 (KR) 10-2025-0035366

(51) Int. Cl. B60K 1/04; B62D 25/02; B62D 25/20

(52) U.S. Cl. CPC B60K 1/04; B62D 25/025; B62D 25/20; B60K 2001/0438

(57) ABSTRACT

A structure of a vehicle body can include a floor shell including a monolithic structure having an upper wall and a side wall configured to define a battery accommodation space and installed to enable the upper wall to partition the battery accommodation space from an indoor vehicle space, a shell flange extending outwards from a lower end of the side wall of the floor shell, and a shell cover configured to enable batteries to be mounted on an upper surface of the shell cover and coupled to the shell flange to seal the batteries within the battery accommodation space.

### CROSS-REFERENCE TO RELATED APPLICATIONS

This application claims priority from Korean Patent Application No. 10-2025-0035366 filed on Mar 19, 2025 in the Korean Intellectual Property Office, the disclosure of which is incorporated herein by reference in its entirety.

### TECHNICAL FIELD

The present disclosure relates to a body structure of a vehicle.

### BACKGROUND

An electric vehicle or a hybrid vehicle is equipped with batteries to provide driving power of the vehicle, and an increase in the capacity of batteries mounted in the vehicle may be expected to extend the driving range.

The batteries mounted in the vehicle should be disposed in a space protected from moisture and foreign matter and should be sufficiently protected from external impact.

The above matters disclosed in this section are merely for enhancement of understanding of the general background of the present disclosure and should not be taken as an acknowledgement or any form of suggestion that the matters form the related art already publicly known, available, or in use.

### SUMMARY

The present disclosure relates to technology associated with a body structure of a vehicle in which batteries are mounted.

Therefore, the present disclosure has been made in view of the above problems, and an embodiment of the present disclosure can provide a body structure of a vehicle capable of not only securing maximization of the capacity of batteries mounted in the vehicle to increase the driving range of the vehicle, but also safely protecting the batteries from moisture, foreign matter, and external impact, thereby enhancing the safety of the vehicle.

Advantages of embodiments of the present disclosure are not necessarily limited to the above-described advantages, and other advantages of embodiments of the present disclosure not yet described can be understood by those skilled in the art from the following detailed description.

In accordance with an embodiment of the present disclosure, the above and other advantages can be accomplished by the provision of a structure of a vehicle body, which can include: a floor shell including a monolithic structure of an upper wall and a side wall configured to define a battery accommodation space and installed to enable the upper wall to partition the battery accommodation space from an indoor vehicle space; a shell flange extending outwards from a lower end of the side wall of the floor shell; and a shell cover configured to enable batteries to be mounted on an upper surface of the shell cover and coupled to the shell flange to seal the batteries within the battery accommodation space.

The upper wall and the side walls of the floor shell may form a single homogeneous and continuous structure.

To fully enclose a horizontal periphery of the battery accommodation space, the side wall of the floor shell may include a front side wall at a front of the vehicle body, a rear side wall at a rear of the vehicle body, and two opposing walls configured to interconnect opposite ends of the front side wall and the rear side wall and positioned at both sides of the vehicle body, respectively.

The structure may further include a shell reinforcement member coupled to the upper wall and the opposing walls to form a closed cross-section in an area where the upper wall and each of the opposing walls are connected.

The structure may further include side sills coupled to the side wall of the floor shell and the shell flange at both sides of the vehicle body, respectively.

The structure may further include a side reinforcement member provided in an area where the upper wall of the floor shell meets each of the side sills, to interconnect the upper wall and the side sill.

A seat cross member may be coupled to an upper surface of the upper wall of the floor shell. The seat cross member may be connected, at opposite ends thereof, to the side sills, respectively.

The seat cross member may be aligned such that an upper height thereof is not higher than an upper height of the side sills. A seat cross extension may be installed between each end of the seat cross member and a corresponding one of the side sills to linearly interconnect an upper surface of the seat cross member and an upper surface of the corresponding side sill.

A plurality of seat mounting brackets may be provided at an upper side of the seat cross member. A part of the seat mounting brackets may be installed to connect the seat cross member, the seat cross extension, and the side sill.

An outer cover member coupled to the shell flange facing the shell flange may be provided at the shell cover to form the battery accommodation space.

The outer cover member may overlap with each of the side sills under the side sill under a condition that the shell flange is interposed between the outer cover member and the side sill. A plurality of mounting elements may extend through and fasten the shell cover, the outer cover member, the shell flange, and the side sill.

The upper wall of the floor shell may be aligned at a vertical center of each of the side sills. A seat cross member may be installed to extend lengthily in a lateral direction of the vehicle body at an upper surface of the upper wall of the floor shell. The height of an upper surface of the seat cross member may be aligned not to be higher than the height of an upper surface of the side sill. Accordingly, a portion of the side sill disposed at an interior of the vehicle body may have a structure in which an upper side thereof with reference to the upper wall of the floor shell is supported by the seat cross member, and a lower side thereof with reference to the upper wall of the floor shell is supported by the side wall of the floor shell, the shell flange, and the shell cover.

A sill reinforcement member having a plurality of closed cross-sections formed as an integrated structure may be provided at an interior of each of the side sills. The reinforcement member may be installed at a height aligned with a seat cross member installed at an upper surface of the upper wall of the floor shell to extend lengthily in a lateral direction of the vehicle body.

A dash floor panel may be disposed above the upper wall at the front of the floor shell. A rear floor panel may be disposed above the upper wall at the rear of the floor shell.

A plurality of seat cross members may be provided between the dash floor panel and the rear floor panel above the upper wall of the floor shell, and a front cross member may be provided at the front of a foremost one of the seat cross members above the upper wall of the floor shell and may be configured to extend lengthily in a lateral direction of the vehicle body. The dash floor panel may be provided with a dash cross member extending lengthily in the lateral direction to interconnect A-pillars at both sides of the vehicle body. A plurality of front upper floor members may be provided to extend lengthily in a longitudinal direction of the vehicle body, for interconnection of the front cross member and the dash cross member.

A plurality of seat cross members may be provided between the dash floor panel and the rear floor panel above the upper wall of the floor shell, and a plurality of rear upper floor members may be provided above the upper wall of the floor shell to support an area between a rearmost one of the seat cross members and the rear floor panel in a longitudinal direction of the vehicle body.

A front mounting member configured to enable the shell flange of the floor shell to be coupled thereto may be provided under the dash floor panel to extend lengthily in the lateral direction of the vehicle body. A front side wall of the floor shell may form closed spaces connected in the lateral direction of the vehicle body, together with the dash floor panel, the front mounting member, and the shell flange.

A dash lower cross member may be provided under the dash floor panel to extend lengthily in the lateral direction of the vehicle body at the front of the front mounting member and to be coupled, at both ends thereof, to opposing front side members, respectively,

A dash lower member may be coupled to a lower side of the dash floor panel to support an area between the dash lower cross member and the front mounting member in a longitudinal direction of the vehicle body. The front side members may be connected to front sides of the side sills, respectively.

A cap nut with a closed top may be provided at an upper surface of the upper wall of the floor shell. A fastening element extending through the shell cover from below may be coupled to the cap nut. The shell cover may be provided with a mounting pipe configured to form an inner space enabling the fastening element to extend therethrough and to support an area between the floor shell and the shell cover. A seal ring may be interposed between the mounting pipe and the upper wall.

An insert nut may be provided at a lower surface of the upper wall of the floor shell. A fastening element extending through the shell cover from below may be coupled to the insert nut. The shell cover may be provided with a mounting pipe configured to form an inner space enabling the fastening element to extend therethrough and to support an area between the floor shell and the shell cover.

### BRIEF DESCRIPTION OF THE DRAWINGS

The above and other features and advantages of example embodiments of the present disclosure can be more clearly understood from the following detailed description taken in conjunction with the accompanying drawings, in which:

FIG. 1 is a perspective view showing a structure of a vehicle body according to an embodiment of the present disclosure;

FIG. 2 is an exploded perspective view showing some parts of the vehicle body of FIG. 1;

FIG. 3 is a perspective view showing a floor shell of FIG. 2 in a vertically inverted state;

FIG. 4 is a perspective view showing the vehicle body of FIG. 1 in a state in which the floor shell, batteries, and a shell cover are removed;

FIG. 5 is a view showing the vehicle body of FIG. 4 observed from below;

FIG. 6 is a perspective view showing a cross-section taken along line F6-F6 in FIG. 5;

FIG. 7 is a view showing a front side of the vehicle body of FIG. 6 in an enlarged state;

FIG. 8 is a view showing a rear side of the vehicle body of FIG. 6 in an enlarged state;

FIG. 9 is a cross-sectional view taken along line F9 in FIG. 1;

FIG. 10 is a cross-sectional view at a same position as FIG. 9, showing an embodiment of a seat cross extension;

FIG. 11 is a cross-sectional view of an embodiment of the present disclosure in which a floor shell and a shell cover are fastened by a fastening element; and

FIG. 12 is a cross-sectional view of an embodiment of the present disclosure in which a floor shell and a shell cover are fastened by a fastening element.

### DETAILED DESCRIPTION OF ILLUSTRATIVE EMBODIMENTS

In the following description of example embodiments of the present disclosure, a detailed description of known technologies incorporated herein can be omitted when it may obscure the subject matter of the example embodiments of the present disclosure. The example embodiments of the present disclosure can be more clearly understood from the accompanying drawings and should not be necessarily limited by the accompanying drawings, and it can be appreciated that changes, equivalents, and substitutes that do not depart from the spirit and technical scopes of the present disclosure can be encompassed in the present disclosure.

It can be understood that, although the terms “first”, “second”, etc. may be used herein to describe various elements, these elements are not necessarily limited by these terms. These terms can be used merely to distinguish one element from another.

Unless clearly used otherwise, singular expressions can include a plural alternative of such.

In this specification, the terms "comprising", "including", or the like, are intended to express the existence of the characteristic, the numeral, the step, the operation, the element, the part, or the combination thereof, and do not exclude another characteristic, numeral, step, operation, element, part, or any combination thereof, or any addition thereto.

In an example where an element is "connected" or "linked" to another element, it can be understood that the element may be directly connected or linked to the other element, or another element may be present therebetween. Conversely, in an example where an element is "directly connected" or "directly linked" to another element, it can be understood that no other element is present therebetween.

Any number of components or a variety of components of any one of the configurations disclosed in example embodiments of the present disclosure may be included in other potential embodiments of the present disclosure. Such components may include any combination of characterized parts disclosed in the present disclosure, and may be arranged to constitute any one of various configurations disclosed in example embodiments of the present disclosure. Not only structures and arrangements of the components of example embodiments of the present disclosure, but also concepts as to use and operation thereof, may be applied not only to particular example embodiments discussed in the present disclosure, but also to other embodiments of any numbers and in any combinations.

Hereinafter, various example embodiments disclosed in the present disclosure will be described in detail with reference to the accompanying drawings, and same or similar elements can be designated by same reference numerals regardless of the numerals in the drawings and redundant description thereof can be omitted.

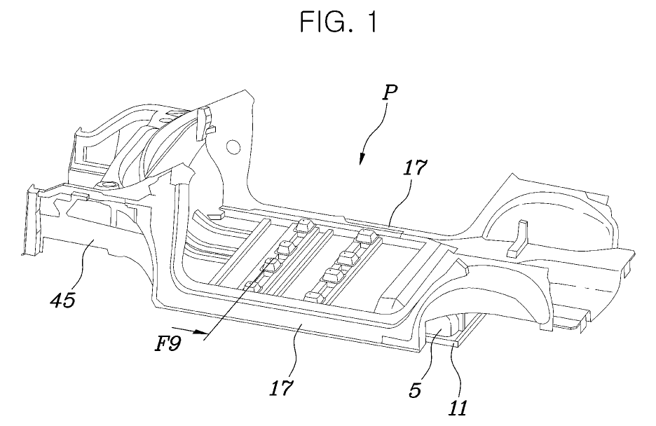

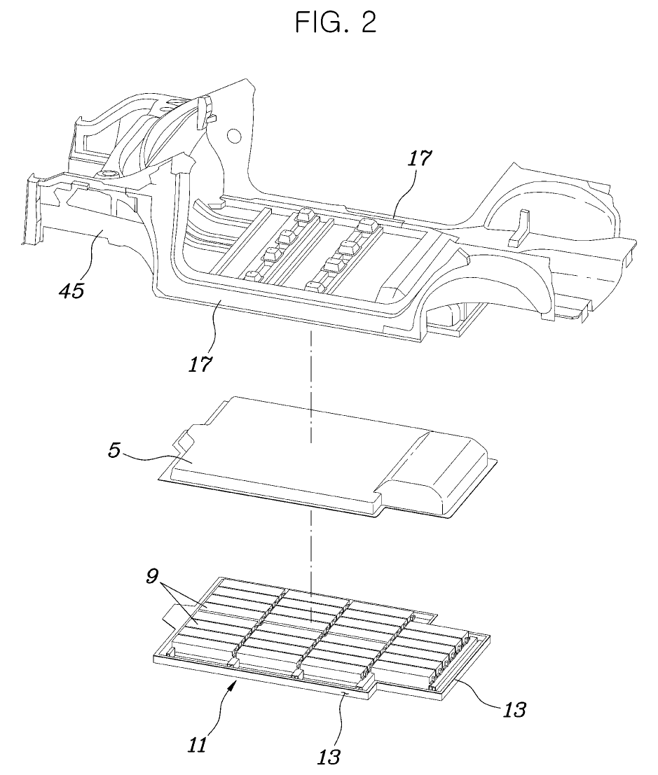

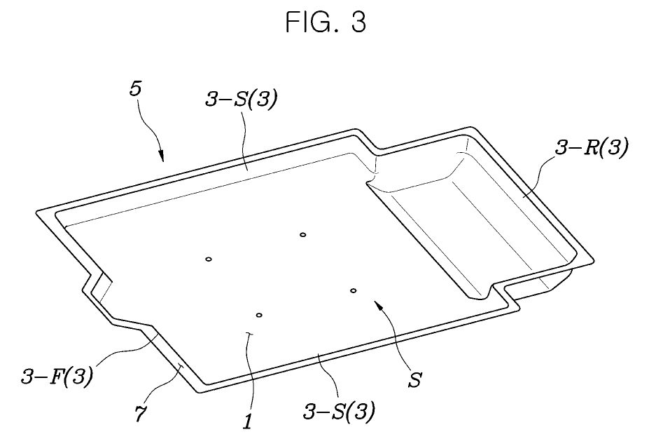

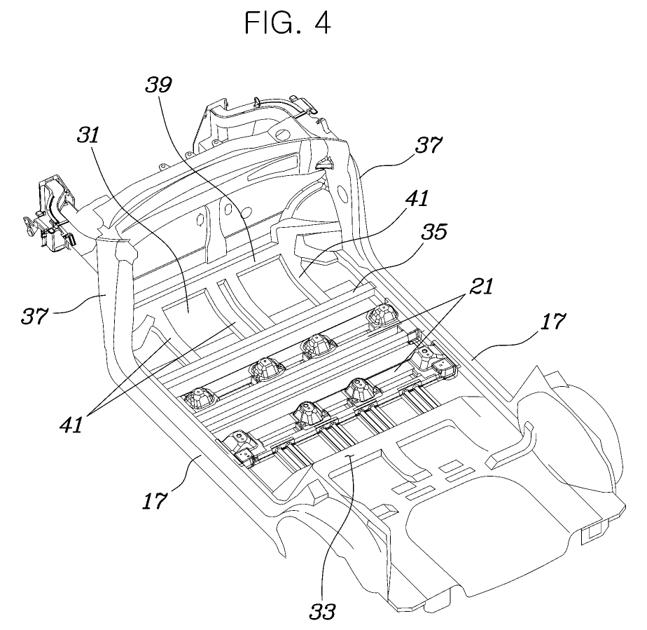

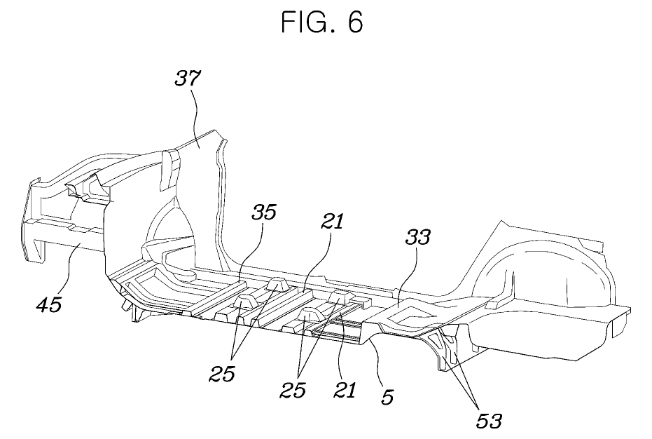

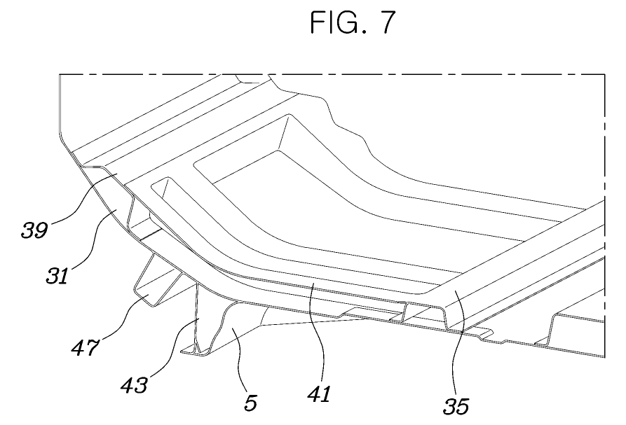

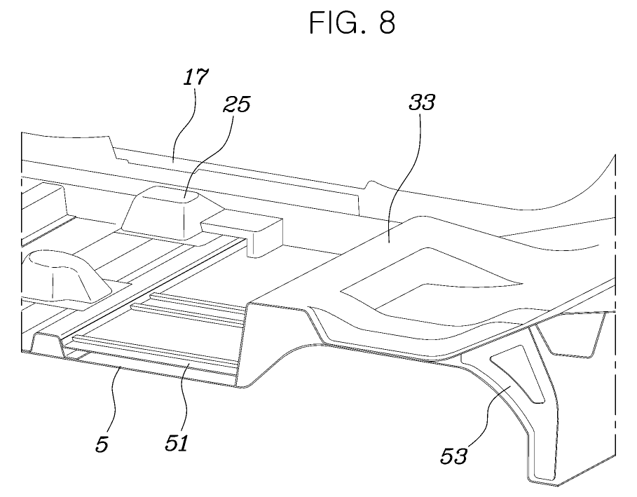

Referring to FIGS. 1 to 11, an embodiment of a structure of a vehicle body of an embodiment of the present disclosure can be configured through inclusion of a floor shell 5 including a monolithic structure of an upper wall 1 and a side wall 3 configured to define a battery accommodation space S and can be installed to enable the upper wall 1 to partition the battery accommodation space S from an indoor vehicle space P, a shell flange 7 extending outwards from a lower end of the side wall 3 of the floor shell 5, and a shell cover 11 configured to enable batteries 9 to be mounted on an upper surface of the shell cover 11 and coupled to the shell flange 7 to seal the batteries 9 within the battery accommodation space S.

The upper wall 1 and the side wall 3 of the floor shell 5 can form a single homogeneous and continuous structure.

That is, the floor shell 5 can be configured to partition the indoor vehicle space P and the battery accommodation space S from each other so that the floor shell 5 can function as both a floor panel and a battery case of a conventional vehicle body. The floor shell 5 can be formed by shaping a single plate using a method such as deep drawing or the like such that the floor shell 5 can have a structure in which the upper wall 1 and the side wall 3 enclose a top side and a periphery of the battery accommodation space S.

The shell cover 11 can be formed to have a simple flat plate shape, and can be configured to be coupled to a lower side of the floor shell 5 in a state in which the batteries 9 are mounted on an upper side of the shell cover 11, and thereby can seal a lower side of the battery accommodation space S.

Accordingly, using an embodiment of the present disclosure, it may be possible to reduce the weight of the vehicle while increasing the degree of freedom of the space allocated for battery installation, as compared to conventional cases, by using the floor shell 5, which can exclude components that traditionally constituted a vehicle body, such as a floor panel, etc., while also serving as a battery case. Ultimately, using an embodiment of the present disclosure, it may be possible to enhance the vehicle's driving range and to achieve superior energy efficiency.

In an embodiment of the present disclosure, the side wall 3 of the floor shell 5 can be configured to fully enclose a horizontal periphery of the battery accommodation space S, through inclusion of a front side wall 3-F at the front of the vehicle body, a rear side wall 3-R at the rear of the vehicle body, and two opposing walls 3-S configured to interconnect opposite ends of the front side wall 3-F and the rear side wall 3-R and positioned at both sides of the vehicle body, respectively.

As shown in the drawings, the front side wall 3-F, the rear side wall 3-R, and the two opposing walls 3-S can form an integrated configuration in which the front side wall 3-F, the rear side wall 3-R, and the two opposing walls 3-S are continuously connected together with the upper wall 1, to completely enclose a periphery of the battery accommodation space S. Accordingly, the battery accommodation space S can be entirely isolated from the outside, such as when the area where the floor shell 5 and shell cover 11 are coupled to each other and sealed. Thus, using an embodiment of the present disclosure, it may be possible to easily secure performance against penetration of moisture and foreign matter.

A sealing component, such as a gasket or the like, can be provided between an outer cover member 13 of the shell cover 11 and the shell flange 7, and the floor shell 5 and the shell cover 11 can be then assembled to pressurize the sealing component so that the battery accommodation space S formed within the floor shell 5 and shell cover 11 can be sealed from the outside environment.

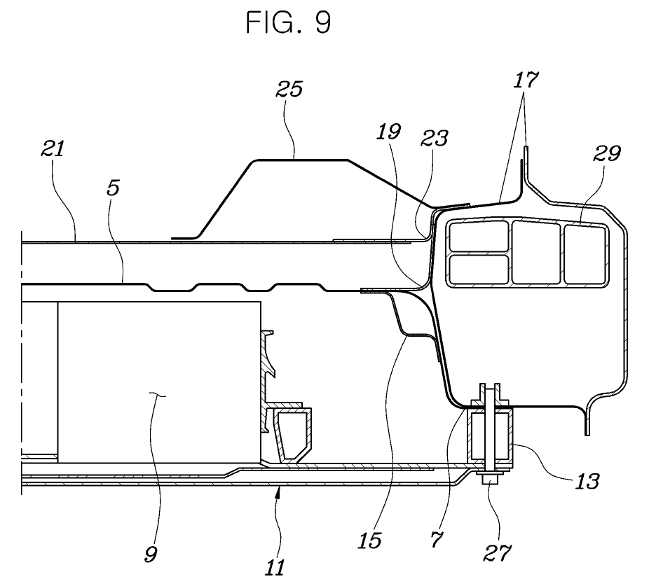

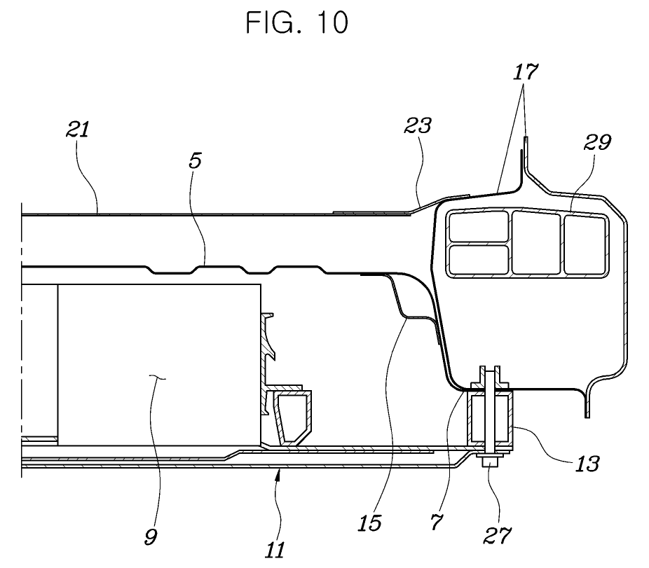

Referring to FIGS. 9 and 10, a shell reinforcement member 15 may be provided within the floor shell 5.

The shell reinforcement member 15, which can be coupled to the upper wall 1 and the opposing walls 3-S, can be configured to extend lengthily in a longitudinal direction of the vehicle body to form a closed cross-section in an area where the upper wall 1 and each opposing wall 3-S are interconnected.

Side sills 17 can be coupled to the side wall 3 of the floor shell 5 and the shell flange 7 can be provided at both sides of the vehicle body, respectively.

Each side sill 17 can be a rigid structure configured to interconnect a front wheelhouse and a rear wheelhouse at a lower portion of each side surface of the vehicle body, to secure stiffness of the vehicle body, and to perform impact absorption and load distribution in the event of a side collision.

Each side sill 17 can be configured such that an inner surface thereof facing inwards toward the vehicle body surface-contacts a corresponding one of the opposing walls 3-S of the floor shell 5, while a lower surface thereof surface-contacts the shell flange 7 extending from the corresponding opposing wall 3-S.

Thus, a coupling structure in which the opposing wall 3-S of the floor shell 5 and the shell flange 7 can enclose the inner and lower surfaces of the side sill 17 can be formed.

Referring to FIG. 9, in an area where the upper wall 1 of the floor shell 5 meets the side sill 17, a side reinforcement member 19 may be further provided to interconnect the upper wall 1 and the side sill 17.

The side reinforcement member 19 can overlap with the shell reinforcement member 15 under the condition that the upper wall 1 of the floor shell 5 is interposed between the side reinforcement member 19 and the shell reinforcement member 15, and can support the floor shell 5 in a state of coupling the floor shell 5 to the side sill 17 from above, and thereby can greatly increase coupling stiffness between the side sill 17 and the floor shell 5.

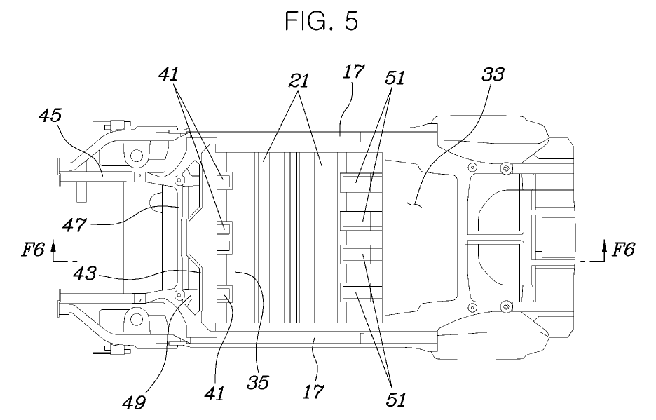

Referring to FIGS. 5, 6, 9, and 10, a seat cross member 21 can be coupled to an upper surface of the upper wall 1 of the floor shell 5. The seat cross member 21 can be connected, at opposite ends thereof, to the side sills 17, respectively.

In an embodiment of the present disclosure, the seat cross member 21 can be connected to each side sill 17 through a seat cross extension 23.

That is, the seat cross extension 23 is configured to interconnect the seat cross member 21 and the side sill 17.

The seat cross member 21 can be aligned such that an upper height thereof is not higher than the upper height of the side sill 17. The seat cross extension 23 can linearly interconnect an upper surface of the seat cross member 21 and an upper surface of the side sill 17 and, as such, the seat cross member 21 may firmly support the side sill 17 through the seat cross extension 23 when impact force is applied from the outside to the side sill 17.

Linear connection between the upper surface of the seat cross member 21 and the upper surface of the side sill 17 by the seat cross extension 23 can provide that, as illustrated in FIG. 10, a portion of the seat cross extension 23 can be interconnecting a portion of the seat cross extension 23 coupled to the upper surface of the seat cross member 21 in an overlapping state and a portion of the seat cross extension 23 can be coupled to the upper surface of the side sill 17 in an overlapping state and can provide a linear cross-sectional structure.

A plurality of seat mounting brackets 25 may be provided at an upper side of the seat cross member 21, and a part of the seat mounting brackets 25 may be installed to connect the seat cross member 21, the seat cross extension 23, and the side sill 17.

A seat can be mounted on the upper side of the seat cross member 21. The seat can be coupled to the seat cross member 21 through the seat mounting brackets 25. Those of the seat mounting brackets 25 positioned at both sides of the vehicle body can be installed to connect all of the seat cross member 21, the seat cross extension 23, and the side sills 17, to form a more rigid connection structure between respective side sills 17 and the seat cross member 21.

The outer cover member 13 can be coupled to the shell flange 7 facing the shell flange 7 provided at the shell cover 11 to form the battery accommodation space S.

The shell cover 11 can have a simple flat plate shape supporting lower portions of the batteries 9, as shown in the drawings. The outer cover member 13 can be installed around the periphery of the shell cover 11 to form a closed curve. When the outer cover member 13 is coupled to the shell flange 7 of the floor shell 5 in an overlapping state, the outer cover member 13 can form the battery accommodation space S together with the floor shell 5.

The outer cover member 13 can overlap with the side sill 17 under the side sill 17 under a condition in which the shell flange 7 is interposed between the outer cover member 13 and the side sill 17. A plurality of mounting elements 27 can extend through and fasten the shell cover 11, the outer cover member 13, the shell flange 7, and the side sill 17.

The shell cover 11 can be fixed to the vehicle body as the plurality of mounting elements 27 extend through and fasten the shell cover 11, the shell flange 7, and the side sill 17 under a condition that, under the shell flange 7, the outer cover member 13 can overlap with the shell flange 7 overlapping with the lower surface of the side sill 17.

Front and rear portions of the shell cover 11 may also be coupled to the shell flange 7 of the floor shell 5 using the plurality of mounting elements 27 in a state in which the outer cover member 13 overlaps with the shell flange 7 of the floor shell 5. A sealing component may be interposed between the outer cover member 13 and the shell flange 7.

Accordingly, using an embodiment of the present disclosure, in an event that maintenance or replacement of the batteries 9 is required, the shell cover 11 and the batteries 9 may be easily disassembled from the vehicle body only through separation of the plural mounting elements 27.

The mounting elements 27 may be components such as bolts, screws, or the like, for example.

The upper wall 1 of the floor shell 5 can be aligned at a vertical center of the side sill 17. The seat cross member 21 can be installed to extend lengthily in a lateral direction of the vehicle body at the upper surface of the upper wall 1 of the floor shell 5. The height of the upper surface of the seat cross member 21 can be aligned not to be higher than the height of the upper surface of the side sill 17. Thus, a portion of the side sill 17 can be disposed at an interior of the vehicle body and can have a structure in which an upper side thereof with reference to the upper wall 1 of the floor shell 5 is supported by the seat cross member 21, and a lower side thereof with reference to the upper wall 1 of the floor shell 5 is supported by the side wall 3 of the floor shell 5, the shell flange 7, and the shell cover 11.

Thus, using an embodiment of the present disclosure, when impact force is applied from the outside of the side sill 17, the floor shell 5, the seat cross member 21, and the shell cover 11 can distribute impact to the center, upper, and lower sides of the side sill 17, respectively, thereby firmly supporting the side sill 17.

Referring to FIGS. 9 and 10, a sill reinforcement member 29 can have a plurality of closed cross-sections formed as an integrated structure and can be provided at an interior of the side sill 17. The sill reinforcement member 29 can be installed at a height aligned with the seat cross member 21 and installed at the upper surface of the upper wall 1 of the floor shell 5 to extend lengthily in the lateral direction of the vehicle body. Accordingly, using an embodiment of the present disclosure, it may be possible to more effectively withstand impact acting from the outside of the side sill 17 through the sill reinforcement member 29 and the seat cross member 21.

A dash floor panel 31 can be disposed above the upper wall 1 at the front of the floor shell 5, and a rear floor panel 33 can be disposed above the upper wall 1 at the rear of the floor shell 5.

That is, the floor shell 5 can be disposed to serve as a center floor between the dash floor panel 31 at the front of the vehicle and the rear floor panel 33 at the rear of the vehicle.

A plurality of seat cross members 21 can be provided between the dash floor panel 31 and the rear floor panel 33 above the upper wall 1 of the floor shell 5. A front cross member 35 can be provided at the front of a foremost one of the seat cross members 21 above the upper wall 1 of the floor shell 5 such that the front cross member 35 extends lengthily in the lateral direction of the vehicle body. The dash floor panel 31 can be provided with a dash cross member 39 extending lengthily in the lateral direction to interconnect A-pillars 37 at both sides of the vehicle body. A plurality of front upper floor members 41 can be provided to extend lengthily in the longitudinal direction of the vehicle body to interconnect the front cross member 35 and the dash cross member 39.

Accordingly, a lattice structure can be formed by the dash cross member 39, the front upper floor members 41, and the front cross member 35 and can provide excellent rigidity and support force to the front of the battery accommodation space S against impact applied from the front of the vehicle body.

A front mounting member 43 can be configured to enable the shell flange 7 of the floor shell 5 to be coupled thereto and can be provided under the dash floor panel 31 to extend lengthily in the lateral direction of the vehicle body. The front side wall 3-F of the floor shell 5 can form closed spaces connected in the lateral direction of the vehicle body, together with the dash floor panel 31, the front mounting member 43, and the shell flange 7.

A dash lower cross member 47 can be provided under the dash floor panel 31 to extend lengthily in the lateral direction of the vehicle body at the front of the front mounting member 43 and to be coupled, at both ends thereof, to opposing front side members 45, respectively. A dash lower member 49 can be coupled to a lower side of the dash floor panel 31 to support an area between the dash lower cross member 47 and the front mounting member 43 in the longitudinal direction of the vehicle body. The front side members 45 can be connected to front sides of the side sills 17, respectively.

Accordingly, using an embodiment of the present disclosure, a multiple support structure can be formed by the front side members 45, the dash lower cross member 47, the dash lower member 49, and the front mounting member 43 and can provide excellent rigidity and support force to the front of the battery accommodation space S against impact applied from the front of the vehicle body.

A plurality of seat cross members 21 can be provided between the dash floor panel 31 and the rear floor panel 33 above the upper wall 1 of the floor shell 5. A plurality of rear upper floor members 51 can be provided above the upper wall 1 of the floor shell 5 to support an area between a rearmost one of the seat cross members 21 and the rear floor panel 33 in the longitudinal direction of the vehicle body.

The rear floor panel 33 can be installed to overlap with a rear part of the floor shell 5. The rear floor panel 33 can be installed to enable a portion of a front part of the rear floor panel 33 to form closed spaces connected to extend lengthily in the lateral direction of the vehicle body, together with the floor shell 5, thereby securing rigidity to support impact acting from the rear of the vehicle body.

For reference, in an embodiment of the present disclosure, a plurality of spaced support brackets 53 can be installed above the floor shell 5 at the rear of the floor shell 5 to interconnect and support the floor shell 5 and a lower surface of the rear floor panel 33.

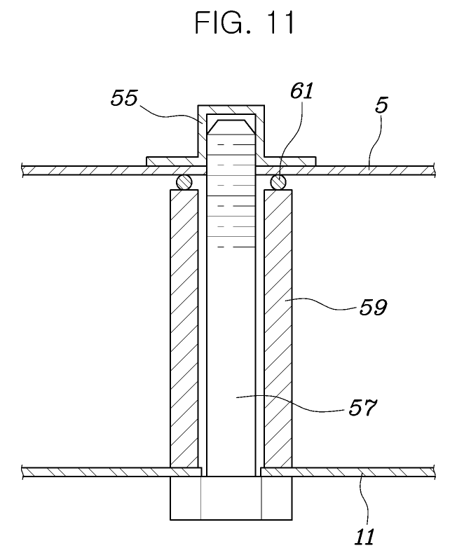

As illustrated in FIG. 11, a cap nut 55 with a closed top can be provided at an upper surface of the upper wall 1 of the floor shell 5. A fastening element 57 extending through the shell cover 11 from below can be coupled to the cap nut 55. The shell cover 11 can be provided with a mounting pipe 59 configured to form an inner space enabling the fastening element 57 to extend therethrough and to support an area between the floor shell 5 and the shell cover 11. A seal ring 61 may be interposed between the mounting pipe 59 and the upper wall 1.

An area of the upper wall 1 of the floor shell 5, in which the cap nut 55 can be mounted, can be perforated to allow the fastening element 57 to pass therethrough. When the cap nut 55 is fixed to the upper wall 1 of the floor shell 5 by welding, for example, it may be difficult to ensure complete watertightness. Thus, the seal ring 61 can be interposed between the mounting pipe 59 and the upper wall 1.

When the fastening element 57 extends through the shell cover 11 from below and is fastened to the cap nut 55, as described above, it may be possible to prevent sagging or the like of the shell cover 11 and to secure a firmer battery mounting state.

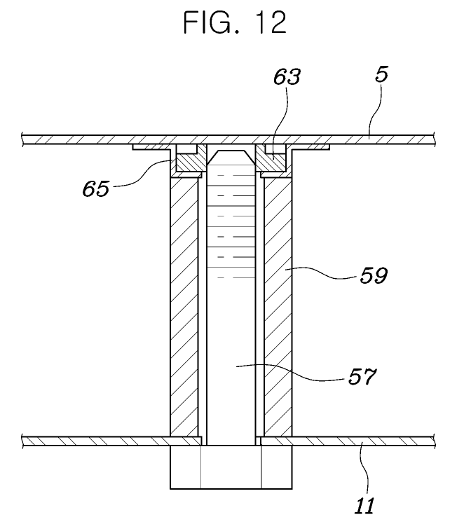

Referring to FIG. 12, an insert nut 63 can be provided at a lower surface of the upper wall 1 of the floor shell 5. A fastening element 57 extending through the shell cover 11 from below can be coupled to the insert nut 63. The shell cover 11 can be provided with a mounting pipe 59 configured to form an inner space enabling the fastening element 57 to extend therethrough and to support an area between the floor shell 5 and the shell cover 11.

The insert nut 63 may be directly fixed to the upper wall 1 of the floor shell 5 using welding or the like. However, fixing of the insert nut 63 may be achieved using a separate nut fixing bracket 65, as shown in FIG. 12.

For reference, the mounting pipe 59 can support the area between the floor shell 5 and the shell cover 11 through the nut fixing bracket 65.

In an embodiment of the present disclosure, there can be an advantage in that enhanced watertightness can be secured because the insert nut 63 for fastening the fastening element 57 can be mounted at the lower surface of the upper wall 1 of the floor shell 5 and, as such, perforation of the floor shell 5 can be unnecessary.

The fastening element 57 may be a component such as a bolt, a screw, or the like, for example.

As can be apparent from the above description, an embodiment of the present disclosure can provide advantages of not only securing maximization of the capacity of batteries mounted in the vehicle to increase the driving range of the vehicle, but also safely protecting the batteries from moisture, foreign matter, and external impact, thereby enhancing the safety of the vehicle.

Advantages that can be attainable in an embodiment of the present disclosure are not necessarily limited to the above-described advantages, and other advantages of an embodiment of the present disclosure not yet described can be understood by those skilled in the art from the above description.

Although example embodiments of the present disclosure have been disclosed for illustrative purposes, those skilled in the art can appreciate that various modifications, additions, and substitutions can be possible, without departing from the scopes and spirit of the disclosure as disclosed in the accompanying claims and equivalents thereof.

What is claimed is:

1. A structure of a vehicle body comprising:
a floor shell comprising a monolithic structure including an upper wall and a side wall configured to define a battery accommodation space and installed to enable the upper wall to partition the battery accommodation space from an indoor vehicle space;
a shell flange extending outwards from a lower end of the side wall of the floor shell; and
a shell cover configured to enable batteries to be mounted on a shell-cover upper surface of the shell cover and coupled to the shell flange to seal the batteries within the battery accommodation space.

2. The structure according to claim 1, wherein the upper wall and the side wall of the floor shell form a single homogeneous and continuous structure.

3. The structure according to claim 2, wherein the side wall of the floor shell comprises:
a front side wall at a front of the vehicle body;
a rear side wall at a rear of the vehicle body; and
two opposing walls configured to interconnect opposite ends of the front side wall and the rear side wall and positioned at both sides of the vehicle body, respectively, such that the side wall fully encloses a horizontal periphery of the battery accommodation space.

4. The structure according to claim 3, further comprising a shell reinforcement member coupled to the upper wall and the opposing walls to form a closed cross-section in an area where the upper wall and each of the opposing walls are connected.

5. The structure according to claim 1, further comprising side sills coupled to the side wall of the floor shell and the shell flange at both sides of the vehicle body, respectively.

6. The structure according to claim 5, further comprising a side reinforcement member provided in an area where the upper wall of the floor shell meets one of the side sills, to interconnect the upper wall and the one of the side sills.

7. The structure according to claim 5, further comprising a seat cross member coupled to an upper-wall upper surface of the upper wall of the floor shell, and wherein the seat cross member is connected, at opposite ends thereof, to the side sills, respectively.

8. The structure according to claim 7, wherein the seat cross member is aligned such that a seat-cross-member upper height thereof is not higher than a side-sills upper height of the side sills; and
wherein the structure further comprises a seat cross extension installed between each end of the seat cross member and a corresponding one of the side sills to linearly interconnect a seat-cross-member upper surface of the seat cross member and a corresponding-side-sill upper surface of the corresponding one of the side sills.

9. The structure according to claim 8, further comprising seat mounting brackets disposed at an upper side of the seat cross member, wherein a part of the seat mounting brackets is installed to connect the seat cross member, the seat cross extension, and the side sill.

10. The structure according to claim 5, further comprising an outer cover member coupled to the shell flange facing the shell flange and disposed at the shell cover to further form the battery accommodation space.

11. The structure according to claim 10, wherein the outer cover member overlaps with a corresponding one of the side sills under the corresponding one of the side sills such that the shell flange is interposed between the outer cover member and the corresponding one of the side sills; and
wherein the structure further comprises mounting elements configured to extend through and fasten the shell cover, the outer cover member, the shell flange, and the corresponding one of the side sills.

12. The structure according to claim 10, wherein the upper wall of the floor shell is aligned at a vertical center of each of the side sills;
wherein a seat cross member is installed to extend lengthily in a lateral direction of the vehicle body at an upper-wall upper surface of the upper wall of the floor shell; and
wherein a seat-cross-member height of a seat-cross-member upper surface of the seat cross member is aligned not to be higher than a corresponding-side-sill height of a corresponding-side-sill upper surface of a corresponding one of the side sills, such that a portion of the corresponding one of the side sills disposed at an interior of the vehicle body has a structural configuration in which an upper side thereof with reference to the upper wall of the floor shell is supported by the seat cross member, and a lower side thereof with reference to the upper wall of the floor shell is supported by the side wall of the floor shell, the shell flange, and the shell cover.

13. The structure according to claim 5, further comprising a sill reinforcement member having closed cross-sections formed as an integrated structure is disposed at an interior of each of the side sills; and
wherein the sill reinforcement member is installed at a height aligned with a seat cross member installed at an upper-wall upper surface of the upper wall of the floor shell to extend lengthily in a lateral direction of the vehicle body.

14. The structure according to claim 1, further comprising:
a dash floor panel disposed above the upper wall at a front of the floor shell; and
a rear floor panel disposed above the upper wall at a rear of the floor shell.

15. The structure according to claim 14, further comprising:
seat cross members disposed between the dash floor panel and the rear floor panel above the upper wall of the floor shell;
a front cross member disposed at a front of a foremost one of the seat cross members above the upper wall of the floor shell, wherein the front cross member is configured to extend lengthily in a lateral direction of the vehicle body;
A-pillars at both sides of the vehicle body, wherein the dash floor panel comprises a dash cross member extending lengthily in the lateral direction to interconnect the A-pillars at both sides of the vehicle body; and
front upper floor members disposed to extend lengthily in a longitudinal direction of the vehicle body, wherein the front upper floor members are configured to interconnect the front cross member and the dash cross member.

16. The structure according to claim 14, further comprising:
seat cross members disposed between the dash floor panel and the rear floor panel above the upper wall of the floor shell; and
rear upper floor members disposed above the upper wall of the floor shell and configured to support an area between a rearmost one of the seat cross members and the rear floor panel in a longitudinal direction of the vehicle body.

17. The structure according to claim 14, further comprising:
a front mounting member disposed under the dash floor panel and extending lengthily in a lateral direction of the vehicle body, wherein the front mounting member is configured to enable the shell flange of the floor shell to be coupled thereto; and
a front side wall of the floor shell together with the dash floor panel, the front mounting member, and the shell flange, form closed spaces connected in the lateral direction of the vehicle body.

18. The structure according to claim 17, further comprising:
side sills coupled to the side wall of the floor shell and the shell flange at both sides of the vehicle body, respectively;
front side members connected to front sides of the side sills, respectively;
a dash lower cross member disposed under the dash floor panel and extending lengthily in the lateral direction of the vehicle body at a front of the front mounting member, wherein the dash lower cross member is coupled, at both ends thereof, to opposing ones of the front side members, respectively; and
a dash lower member coupled to a lower side of the dash floor panel to support an area between the dash lower cross member and the front mounting member in a longitudinal direction of the vehicle body.

19. The structure according to claim 1, further comprising:
a cap nut with a closed top disposed at an upper-wall upper surface of the upper wall of the floor shell;
a fastening element extending through the shell cover from below and coupled to the cap nut;
wherein the shell cover includes a mounting pipe configured to form an inner space enabling the fastening element to extend therethrough and to support an area between the floor shell and the shell cover; and
a seal ring interposed between the mounting pipe and the upper wall.

20. The structure according to claim 1, further comprising:
an insert nut disposed at an upper-wall lower surface of the upper wall of the floor shell;
a fastening element extending through the shell cover from below and coupled to the insert nut; and
wherein the shell cover includes a mounting pipe configured to form an inner space enabling the fastening element to extend therethrough and to support an area between the floor shell and the shell cover.
